(19) United States
(12) Patent Application Publication
(10) Pub. No.: US 2011/0122575 A1
(43) Pub. Date: May 26, 2011

(54) WORKSPACE DEVICE

(76) Inventor: Edgar Diego Haren, Houston, TX (US)

(21) Appl. No.: 12/624,540

(22) Filed: Nov. 24, 2009

(51) Int. Cl. G06F 1/16

(52) U.S. Cl. 361/679.55

(57) ABSTRACT

A computing machine including a processor, a workspace device coupled to one or more mounting mechanisms and configured to extend and retract from the computing machine, and one or more locking mechanisms configured to lock the workspace device in one or more positions in response to the workspace device extending and retracting from the computing machine.

### BACKGROUND

When utilizing a workspace or a working area for a computing machine, a user can initially access an available desk or an accessory around the computing machine to operate as the workspace. Once the desk or the accessory has been prepared, the user can proceed to utilize the desk or the accessory as a workspace or a working area for the computing machine.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a computing machine coupled to a workspace device and a mounting mechanism according to an embodiment of the invention.

FIG. 2A and FIG. 2B illustrate a workspace device coupled to one or more mounting mechanisms and one or more locking mechanisms according to embodiments of the invention.

FIG. 3A and FIG. 3B illustrate a workspace device coupled to a computing machine through one or more mounting mechanisms and the workspace device repositioning according to embodiments of the invention.

FIG. 4A, FIG. 4B, FIG. 4C, and FIG. 4D illustrate one or more components coupled to a workspace device according to embodiments of the invention.

FIG. 5A and FIG. 5B illustrate one or more components coupled to a workspace device according to other embodiments of the invention.

FIG. 6 is a flow chart illustrating a method for repositioning a workspace device according to an embodiment of the invention.

FIG. 7 is a flow chart illustrating a method for repositioning a workspace device according to another embodiment of the invention.

### DETAILED DESCRIPTION

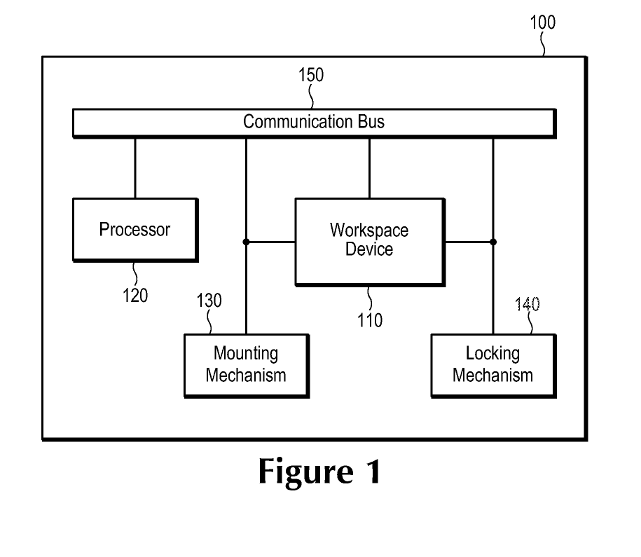

FIG. 1 illustrates a computing machine 100 coupled to a workspace device 110 and a mounting mechanism 130 according to an embodiment of the invention. The computing machine 100 can be a desktop, a notebook, a netbook, and/or any device which the workspace device 110 can be coupled to. As illustrated in FIG. 1, the computing machine 100 includes a processor 120, a communication bus 150, a workspace device 110, one or more mounting mechanisms 130, and one or more locking mechanisms 140.

In another embodiment, the computing machine 100 additionally includes a power supply and/or a heat sink for one or more components of the computing machine 100. In other embodiments, the computing machine 100 includes additional components and/or is coupled to additional components in addition to and/or in lieu of those noted above and illustrated in FIG. 1.

As noted above, the computing machine 100 includes a processor 120. The processor 120 is coupled to and communicates with one or more components of the computing machine 100. The processor 120 can control one or more components of the computing machine 100 by sending, receiving, and/or executing instructions, through the communication bus 150, for one or more of the components of the computing machine 100, such as the workspace device 110.

A workspace device 110 is a device which is coupled to the computing machine 100 and is configured to operate as a workspace or working area for the computing machine 100. Additionally, the workspace device 110 can be configured to extend from the computing machine 100 and/or retract to the computing machine 100 through one or more of the mounting mechanisms 130. Further, the workspace device 110 can be configured to lock into one or more positions when extending and/or retracting to and from the computing machine 110 through one or more locking mechanisms 140.

Additionally, a composition of the workspace device 110 can include one or more alloys, one or more plastics, and/or a combination of the above. In other embodiments, a composition of the workspace device 110 can include additional compounds and/or a combination of compounds.

In one embodiment, the workspace device 110 additionally includes one or more components. One or more of the components can include at least one from the group consisting of one or more interfaces for the computing machine 100, one or more input devices for the computing machine 100, one or more display devices for the computing machine 100, one or more touch screens for the computing machine 100, one or more heat dissipation devices for the computing machine 100, and/or one or more charging stations for additional devices. Additionally, one or more of the components included in the workspace 110 can be coupled to one or more components of the computing machine 100, such as the communication bus 150, the power supply and/or the heat sink.

As noted above, the workspace device 110 is coupled to the computing machine 100 through one or more mounting mechanisms 130. One or more mounting mechanisms 130 are mounting devices which are coupled to the computing machine 100 and are configured to couple the workspace device 110 to the computing machine 100. Additionally, one or more of the mounting mechanisms 130 are configured to extend and/or retract the workspace 110 from the computing machine 100 by repositioning and/or rotating the workspace device 110 along one or more axis.

Additionally, when extending and/or retracting from the computing machine 100, the workspace device 110 can lock into one or more positions through one or more locking mechanisms 140. One or more locking mechanisms 140 are locking devices configured to secure the workspace device 110 in one or more positions in response to the workspace device 110 extending and/or retracing from the computing machine 100.

Further, one or more of the locking mechanisms 140 can manually be configured by a user to secure the workspace device 110 in one or more of the positions. Additionally, one or more of the locking mechanisms 140 can automatically be configured by the processor 120 to secure the workspace device 110 in one or more of the positions in response to the workspace device 110 extending and/or retracting.

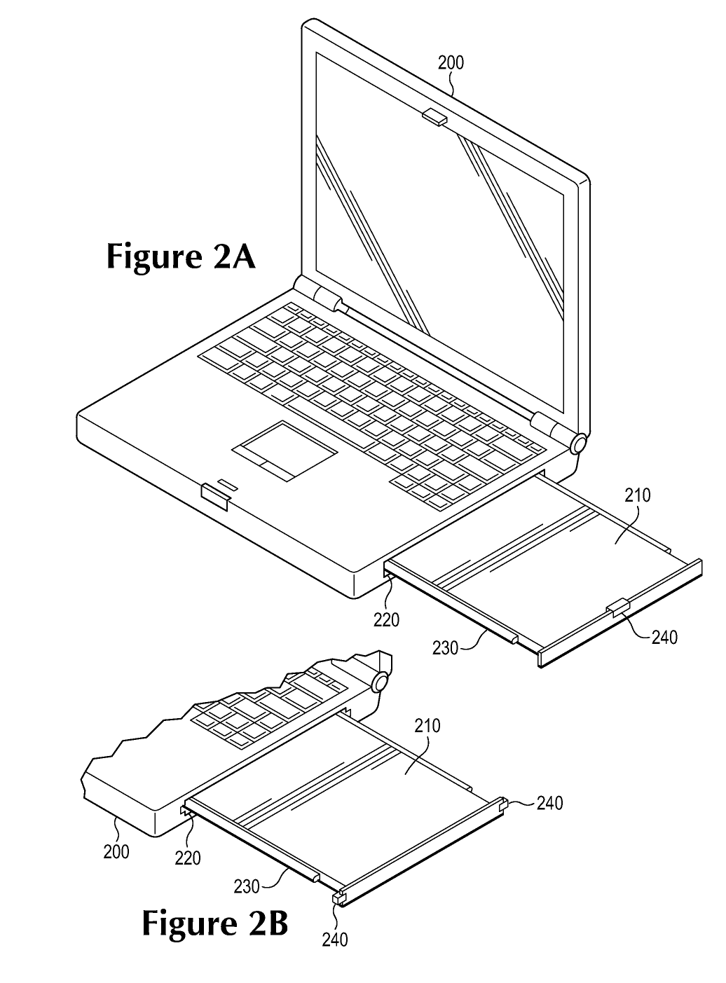

FIG. 2A and FIG. 2B illustrate a workspace 210 device coupled to one or more mounting mechanisms 230 and one or more locking mechanisms 240 according to embodiments of the invention. As noted above, one or more mounting mechanisms 230 are coupled to a computing machine 200 and are configured to couple the workspace device 210 to the computing machine 200.

As illustrated in FIG. 2A and FIG. 2B, in one embodiment, one or more of the mounting mechanisms 230 include one or more rails. In another embodiment, one or more of the mounting mechanisms 230 can include one or more hinges. In other embodiments, one or more of the mounting mechanisms 230 can include additional devices and/or components configured to couple the workspace device 210 to the computing machine 200 and configured to extend and/or retract the workspace device 210 from the computing machine 200.

As illustrated in FIG. 2A and FIG. 2B, one or more of the rails 230 couple to both sides of the workspace device 210 and couple to both sides of a compartment 220 of the computing machine 200. In another embodiment, one or more of the mounting mechanisms 230 are coupled to a keyboard of the computing machine 200. In other embodiments, one or more of the mounting mechanisms 230 are coupled to a base of the computing machine 200.

As a result, as illustrated in FIG. 2, the workspace device 210 can be configured to extend and/or retract into one or more positions from the compartment 220 of the computing machine 200, a keyboard of the computing machine 200, and/or a base of the computing machine 200. One or more of the positions can include an open position and/or a closed position. As illustrated in FIG. 2A and FIG. 2B, in one embodiment, when extended from the computing machine 200, the workspace device 210 is in an open position and can be used as a workspace by a user of the computing machine 200. In another embodiment, when retracted to the computing machine 200, the workspace device 210 is in a closed position.

As illustrated in FIG. 2A and FIG. 2B, the workspace device 210 can be configured to extend to an open position from the compartment 220 by sliding out of the compartment 220 along the rails 230 (one or more mounting mechanisms). Additionally, the workspace device 210 can be configured to retract to a closed position in the compartment 220 by slide into the compartment 220 along the rails 230 (one or more of the mounting mechanisms).

In repositioning and/or rotating the workspace device 210, a user can manually access the workspace device 210 to manually reposition and/or rotate the workspace device 210. In another embodiment, one or more of the mounting mechanisms 230 can include one or more motors configured by a processor of the computing machine 200 to automatically extend and/or retract the workspace device 210 from the computing machine 200. One or more of the mounting mechanisms 230 can automatically extend and/or retract the workspace device 210 from the computing machine 200 in response to a user accessing the workspace device 210.

Further, as noted above, one or more locking mechanisms 240 can be configured to secure the workspace device 210 in one or more positions. As illustrated in FIG. 2A and FIG. 2B, one or more of the locking mechanisms 240 can include one or more latches configured to lock the workspace device 210 in one or more of the positions. In another embodiment, one or more of the locking mechanisms 240 can include a spring lock. In other embodiments, one or more of the locking mechanisms 240 can include additional devices and/or components configured to secure the workspace device 210 in one or more positions in response to the workspace device extending and/or retracting from the computing machine 200.

As shown in FIG. 2A, in one embodiment, one or more of the locking mechanisms 240 can be coupled to a center top position of the workspace device 210. In another embodiment, as shown in FIG. 2B, one or more of the locking mechanisms 240 can be coupled to opposite ends of the workspace device 210. In other embodiments, one or more locking mechanisms 240 can be located at additional locations and be configured to secure the workspace device 210 in additional positions in addition to and/or in lieu of those noted above and illustrated in FIG. 2A and FIG. 2B.

Further, in response to accessing the workspace device 210, one or more of the locking mechanisms 240 can secure the workspace device 210 in a closed position and/or an open position. One or more of the locking mechanisms 240 can secure the workspace device 210 in a closed position when the workspace device 210 is retracted by coupling an end of the workspace device 210 to the computing machine 200.

In response to a user accessing the workspace device 210, one or more of the locking mechanisms 240 can release the workspace device 210 from the closed position. In one embodiment, a user can access the workspace device 110 by accessing a button located on the workspace device 210 or the computing machine 200. In another embodiment, the user can access the workspace device 110 by accessing one or more of the locking mechanisms 210.

As illustrated in FIG. 2A and FIG. 2B, once the workspace device 210 has been accessed, one or more of the locking mechanisms 240 can release an end of the workspace device 210 from the computing machine 200 and the workspace device 210 can proceed to reposition into an open position. In one embodiment, one or more of the locking mechanisms 240 can additionally secure the workspace device 210 in an open position.

When the workspace device 210 is retracted in a closed position, the hinges and/or latches 240 of FIG. 2A and FIG. 2B can couple to the computing machine 200 such that the workspace device 210 is secured within the compartment 220 of the computing machine 200. Additionally, when a user would like to access the workspace device 210, the hinges and/or latches 240 can be configured to manually and/or automatically decouple from the computing machine 200 so that the workspace device 210 can extend to an open position.

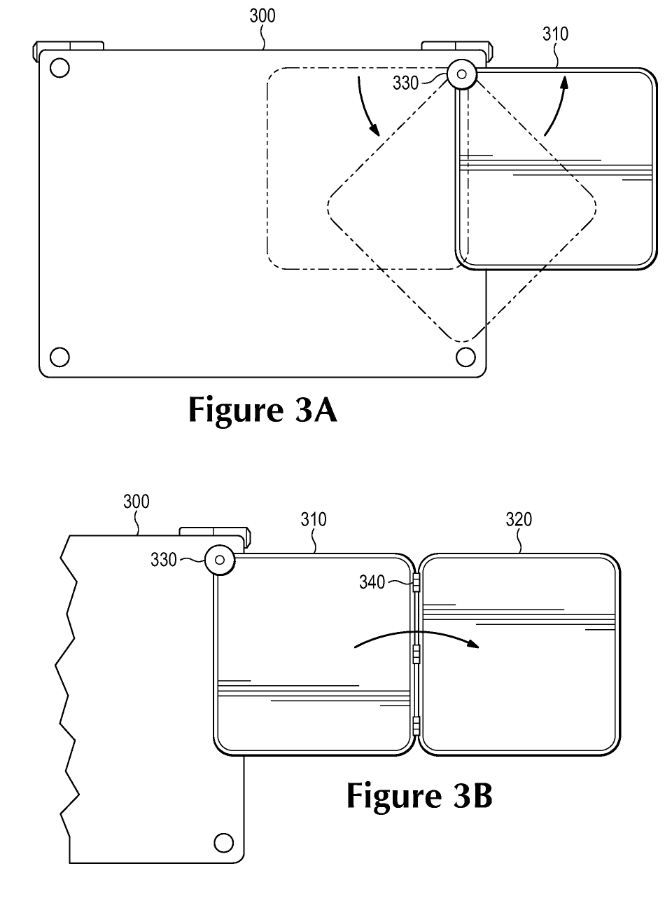

FIG. 3A and FIG. 3B illustrate a workspace device 310 coupled to a computing machine 300 through one or more mounting mechanisms 330 and the workspace device 310 repositioning according to embodiments of the invention. As noted above, and as illustrated in FIG. 3A and FIG. 3B, in one embodiment, one or more of the mounting mechanisms 330 can include one or more hinges 330.

As illustrated in FIG. 3A and FIG. 3B, a hinge 330 can be coupled to a base of the computing machine 300 and the hinge 330 is configured to couple the workspace device 310 to the computing machine 300. Additionally, as illustrated in FIG. 3A and FIG. 3B, the hinge 330 can be located at a corner position of the computing machine 300. In other embodiments, one or more hinges 330 can be coupled to additional locations on the computing machine 300.

Additionally, as shown in the present embodiments, when one or more of the hinges 330 are coupled to a base of the computing machine 300, one or more hinges 330 can additionally operate as a bottom support or a leg for the computing machine 300.

As noted above, the workspace device 310 can extend to one or more positions by rotating along one or more axis. As illustrated in FIG. 3A and FIG. 3B, when coupled to the hinge 330, the workspace device 310 can rotate 360 degrees around an axis to an open position and/or a closed position. In other embodiments, one or more hinges 330 can be utilized to fold the workspace device 310 into one or more positions.

Additionally, as illustrated in FIG. 3B, in one embodiment, the workspace device 310 additionally includes one or more panels 320. One or more panels 320 are plates which are coupled to the workspace device 310 and are configured to extend and/or retract from the workspace device 310 when the workspace device 310 is extended to an open position. In other embodiments, one or more of the panels 320 can be configured to extend when the workspace device 310 is extended and/or retracted in one or more additional positions.

As illustrated in FIG. 3, one or more of the panels 320 can extend out from the workspace device 310 by rotating and/or folding from the workspace device 310. As shown in FIG. 3B, one or more of the panels 320 can be coupled to the workspace device 310 through one or more additional hinges 340

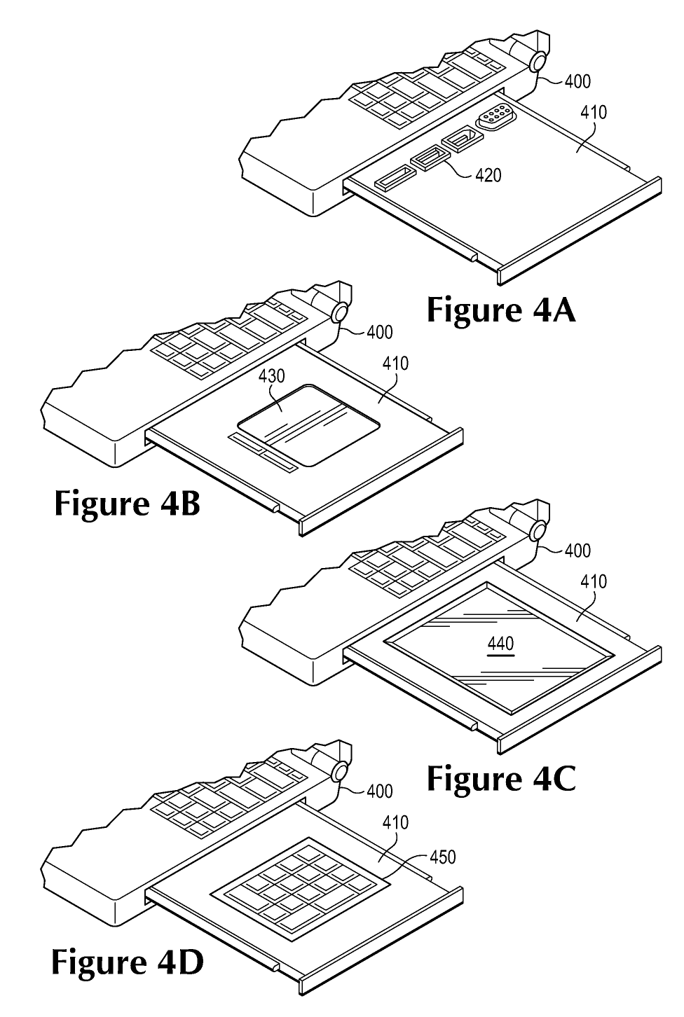

FIG. 4A, FIG. 4B, FIG. 4C, and FIG. 4D illustrate one or more components 420, 430, 440, 450 coupled to a workspace device 410 according to embodiments of the invention. As illustrated in FIG. 4A, FIG. 4B, FIG. 4C, and FIG. 4D, the workspace device 410 is coupled to a computing machine 400 through one or more mounting mechanisms.

As noted above, in one embodiment, the workspace device 410 can include one or more components 420, 430, 440, and 450. Additionally, as noted above, one or more of the components 420, 430, 440, 450 of the workspace 410 can be coupled to one or more components of the computing machine 400, such as a communication bus of the computing machine 400, a power supply of the computing machine 400, and/or a heat sink of the computing machine 400. In other embodiments, one or more components 420, 430, 440, 450 of the workspace 410 can be coupled to additional components of the computing machine 400 in addition to and/or in lieu of those noted above.

As shown in FIG. 4A, in one embodiment, one or more of the components 420 can include one or more interfaces 420 for the computing machine 400. Additionally, as shown in FIG. 4A, one or more of the interfaces 420 can include a serial ATA interface, a USB interface, a Firewire interface, and/or a VGA interface. As noted above, one or more of the interfaces 420 can be coupled to a communication bus of the computing machine 400 to transfer data when one or more of the interfaces 420 are accessed. In other embodiments, one or more of the interfaces 420 can include additional forms of interfaces in addition to and/or in lieu of those noted above and illustrated in FIG. 4A.

Additionally, as illustrated in FIG. 4B, FIG. 4C, and FIG. 4D, in one embodiment, one or more components 430, 440, and 450 can include one or more input devices and/or one or more display devices. Further, as noted above, one or more of the input devices can be coupled to the communication bus of the computing machine 400 to receive and transmit data and/or input commands received from the input devices and sent to the input devices.

As shown in FIG. 4B, in one embodiment, one or more of the input devices 430 can include a mouse or track pad 430. In another embodiment, as illustrated in FIG. 4C, one or more of the input devices 440 can include a display device and/or a touch screen device 440. In other embodiments, as illustrated in FIG. 4D, one or more of the input devices 450 can include a number pad 450.

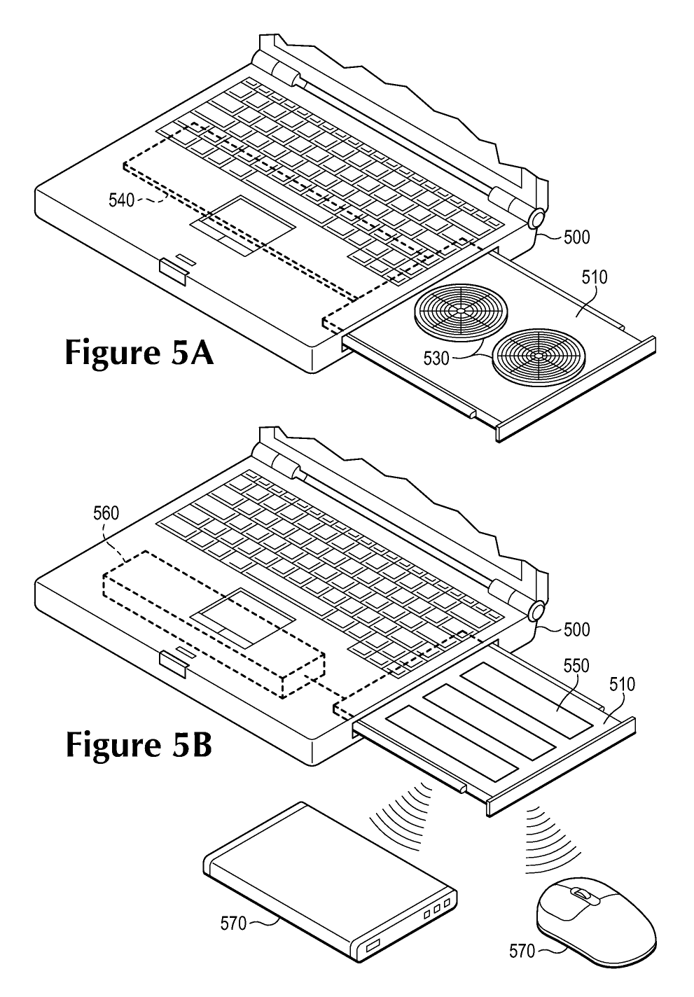

FIG. 5A and FIG. 5B illustrate one or more components 530, 550 coupled to a workspace device 510 according to other embodiments of the invention. As noted above and as illustrated in FIG. 5A and FIG. 5B, the workspace device 510 can be coupled one or more components 530, 550. Additionally, as illustrated in FIG. 5A and FIG. 5B, the workspace device 510 can be coupled to the computing machine 500 through one or more mounting mechanisms.

As noted above, in one embodiment, one or more of the components of the workspace device 510 can be a heat dissipation device 530. Additionally, as illustrated in FIG. 5A and as noted above, the heat dissipation device 530 can be coupled to one or more components of the computing machine 500. As shown in the present embodiment, the heat dissipation device 530 of the workspace device 510 can be coupled to a heat sink 540 of the computing machine 500. As shown in FIG. 5A, the heat dissipation device 530 can include one or more fans configured to rotate and dissipate transferred from the heat sink 540.

In another embodiment, as shown in FIG. 5B, one or more of the components of the workspace device 510 can include one or more charging stations 550. As shown FIG. 5B, the charging station 550 can be coupled to a power supply 560 of the computing machine 500. The workspace device 510 can configure the power supply 560 of the computing machine 500 to transfer electrical energy from the power supply 560 to charge one or more additional devices 570. In one embodiment, one or more of the additional devices 570 can be charged wireless through electromagnetic induction. In other embodiments, one or more of the additional devices 570 can be coupled to the charging station 550 and be charged through inductive charging.

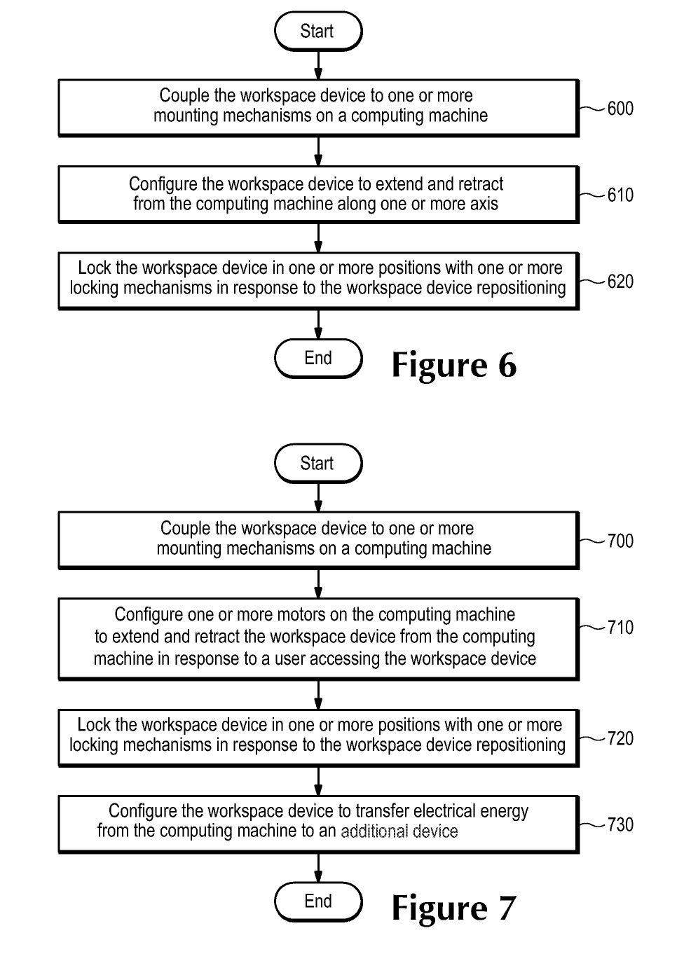

FIG. 6 is a flow chart illustrating a method for repositioning a workspace device according to an embodiment of the invention. The method of FIG. 6 uses a computing machine coupled to one or more mounting mechanisms, a workspace device, and one or more locking mechanisms. In another embodiment, the method of FIG. 6 additionally utilizes one or more additional components of the computing machine and one or more components coupled to the workspace device. In other embodiments, the method of FIG. 6 uses additional components and/or devices in addition to and/or in lieu of those noted above and illustrated in FIGS. 1, 2A, 2B, 3A, 3B, 4A, 4B, 4C, 4D, 5A, and 5B.

As noted above, a workspace device is a device which is coupled to the computing machine and is configured to operate as a workspace or working area for the computing machine. Additionally, as noted above, one or more mounting mechanisms are configured to couple the workspace device to the computing machine 600. One or more mounting mechanisms are mounting devices which can be located in various positions on the computing machine to couple the workspace device to the computing machine.

In one embodiment, one or more of the mounting mechanisms include one or more rails. In another embodiment, one or more of the mounting mechanisms include one or more hinges. In other embodiments, one or more of the mounting mechanisms can include additional devices and/or components configured to couple the workspace device to the computing machine and configured to extend and/or retract the workspace device from the computing machine.

When the workspace device is coupled to the computing machine, one or more of the mounting mechanisms are configured to extend and/or retract the workspace from the computing machine by repositioning and/or rotating the workspace device along one or more axis 610. As noted above, the workspace device can be extended into one or more positions. Additionally, as noted above, one or more of the positions can include an open position and a closed position.

In one embodiment, when repositioning and/or rotating the workspace device, a user can manually access the workspace device to manually reposition and/or rotate the workspace device. In another embodiment, one or more of the mounting mechanisms can include one or more motors and be configured by a processor of the computing machine to automatically extend and/or retract the workspace device from the computing machine in response to a user accessing the workspace device.

Additionally, when extending and/or retracting into one or more positions, one or more locking mechanisms can lock the device in one or more of the positions in response to the workspace device repositioning 620. As noted above, one or more locking mechanisms are locking devices configured to secure the workspace device in one or more positions in response to the workspace device extending and/or retracing from the computing machine.

One or more of the locking mechanisms can include one or more latches configured to lock the workspace device in one or more of the positions. In another embodiment, one or more of the locking mechanisms can include a spring lock. In other embodiments, one or more of the locking mechanisms can include additional devices and/or components configured to secure the workspace device in one or more positions in response to the workspace device extending and/or retracting from the computing machine.

Further, one or more of the locking mechanisms can manually be configured by a user to secure the workspace device in one or more of the positions. Additionally, one or more of the locking mechanisms can automatically be configured by the processor to secure the workspace device in one or more of the positions in response to the workspace device extending and/or retracting. In one embodiment, the method is then complete. In other embodiments, the method of FIG. 6 includes additional steps in addition to and/or in lieu of those depicted in FIG. 6.

FIG. 7 is a flow chart illustrating a method for repositioning a workspace device according to another embodiment of the invention. Similar to the method disclosed in FIG. 6, the method of FIG. 7 uses a computing machine coupled to one or more mounting mechanisms, a workspace device, and one or more locking mechanisms. In another embodiment, the method of FIG. 7 additionally utilizes one or more additional components of the computing machine and one or more components coupled to the workspace device. In other embodiments, the method of FIG. 7 uses additional components and/or devices in addition to and/or in lieu of those noted above and illustrated in FIGS. 1, 2A, 2B, 3A, 3B, 4A, 4B, 4C, 4D, 5A, and 5B.

As noted above, a workspace device is a device which is coupled to the computing machine and is configured to operate as a workspace or working area for the computing machine. One or more mounting mechanisms are initially configured to couple the workspace device to the computing machine 700. One or more mounting mechanisms are mounting devices which couple the workspace device to the computing machine. Additionally, one or more of the mounting mechanisms can be coupled to one or more locations on the computing machine. As a result, the workspace device can be coupled to various locations on the computing machine and be configured to extend and/or retract into one or more positions in response to a user accessing the workspace device 710.

As noted above, in one embodiment, when repositioning and/or rotating the workspace device, a user can manually access the workspace device to manually reposition and/or rotate the workspace device. In another embodiment, one or more of the mounting mechanisms can include one or more motors and be configured by a processor of the computing machine to automatically extend and/or retract the workspace device from the machine in response to a user accessing the workspace device.

Additionally, when extending and/or retracting into one or more positions, one or more locking mechanisms can lock the device in one or more of the positions in response to the workspace device repositioning 720. As noted above, one or more locking mechanisms are locking devices configured to secure the workspace device in one or more positions in response to the workspace device extending and/or retracing from the computing machine.

Further, one or more of the locking mechanisms can manually be configured by a user to secure the workspace device in one or more of the positions. Additionally, one or more of the locking mechanisms can automatically be configured by the processor to secure the workspace device in one or more of the positions in response to the workspace device extending and/or retracting.

In one embodiment, when the workspace device is extended from the computing machine, the workspace device can be secured in an open position. In another embodiment, when the workspace device is retracted to the computing machine, the workspace device can secure the workspace device in a closed position.

As noted above, in one embodiment, once the workspace device has been extended into an open position, the workspace device can be utilized by a user as a working area or a workspace area. Additionally, as noted above, in one embodiment, the workspace device includes one or more components. When extended into an open position, one or more components included in the workspace device can be utilized.

As noted above, one or more of the components can include at least one from the group consisting of one or more interfaces for the computing machine, one or more input devices for the computing machine, one or more display devices for the computing machine, one or more touch screens for the computing machine, one or more heat dissipation devices for the computing machine, and/or one or more charging stations for additional devices.

Additionally, as noted above, one or more of the components included in the workspace can be coupled to one or more components of the computing machine, such as a communication bus of the computing machine, a power supply of the computing machine, and/or a heat sink of the computing machine.

When one or more of the components include a charging station, the workspace device configures the power supply of the computing machine to transfer electrical energy from the computing machine to charge additional devices 730. As noted above, the charging station can charge the additional devices wireless through electromagnetic induction. In another embodiment, the additional devices are coupled to the workspace device and the additional devices are charged through induction. In one embodiment, the method is then complete. In other embodiments, the method of FIG. 7 includes additional steps in addition to and/or in lieu of those depicted in FIG. 7.

By coupling a workspace device to a computing machine with one or more mounting mechanisms and configuring the workspace device to extend or retract, the workspace device can conveniently be accessed by a user and securely be stowed away on the computing machine. Additionally, by including one or more components in the workspace device and coupling to one or more components of the computing machine, the workspace device can operate as an input device, an interface to additional devices, a heat sink, and/or a charging station for additional devices.

What is claimed is:

1. A computing machine comprising:
a processor;
a workspace device coupled to one or more mounting mechanisms and configured to extend and retract from the computing machine; and
one or more locking mechanisms configured to lock the workspace device in one or more positions in response to the workspace device extending and retracting from the computing machine.

2. The computing machine of claim 1 further comprising a compartment configured to house the workspace device when the workspace device is in a closed position.

3. The computing machine of claim 1 wherein one or more of the mounting mechanisms are coupled to a keyboard of the computing machine and the workspace device is extends and retracts from the keyboard.

4. The computing machine of claim 1 wherein one or more of the mounting mechanisms are coupled to a base of the computing machine and the workspace device extends and retracts from the base of the computing machine.

5. The computing machine of claim 1 wherein one or more of the mounting mechanisms are sliding rails configured to allow the workspace device to slide into an extended position and a retracted position.

6. The computing machine of claim 1 wherein one or more of the mounting mechanisms include a hinge coupled to the workspace device and configured to rotate the workspace device along one or more axis into an extended position and a retracted position.

7. The computing machine of claim 1 wherein one or more of the mounting mechanisms include a motor configured to extend and retract the workspace device in response to the workspace device being accessed.

8. A computing machine comprising:
a processor;
one or more mounting mechanisms;
a workspace device coupled to one or more of the mounting mechanisms and configured to extend to an open position and retract to a closed position; and
one or more locking mechanisms configured to lock the workspace device in the open position and the closed position in response to the workspace device extending from and retracting to the computing machine.

9. The computing machine of claim 8 wherein one or more of the locking mechanisms includes one or more latches configured to lock the workspace device in a retracted position and an extended position.

10. The computing machine of claim 8 wherein one or more of the locking mechanisms includes a spring lock.

11. The computing machine of claim 8 wherein the workspace device includes one or more additional panels configurable to extend and retract once the workspace device has been extended to the open position.

12. The computing machine of claim 11 wherein one or more of the additional panels are configurable to lock into an extended position and a retracted position when the workspace device is extended from the computing machine.

13. The computing machine of claim 8 wherein the workspace device includes one or more input devices.

14. The computing machine of claim 13 wherein one or more of the input devices include at least one from the group consisting of a number pad, a mouse pad, and a touch screen.

15. The computing machine of claim 8 wherein the workspace device includes one or more interfaces configured to coupled with one or more additional devices.

16. The computing machine of claim 8 wherein the workspace device is coupled to a power supply of the computing machine and the workspace device is configured to operate as a charging station for one or more additional devices.

17. The computing machine of claim 8 wherein the workspace device is coupled to a heat sink of the computing machine and is configured to dissipate heat transferred from the heat sink.

18. A method for repositioning a workspace device comprising:
coupling the workspace device to one or more mounting mechanisms on a computing machine;
configuring the workspace device to extend and retract from the computing machine along one or more axis; and
locking the workspace device in one or more positions with one or more locking mechanisms in response to the device repositioning.

19. The method of claim 18 further comprising configuring one or more motors on the computing machine to extend or retract the workspace device in response to a user accessing the device.

20. The method of claim 18 further comprising configuring the workspace device to transfer electrical energy from the computing machine to an additional device.
